(19) United States
(12) Patent Application Publication
(10) Pub. No.: US 2014/0122016 A1
(43) Pub. Date: May 1, 2014

(54) Machine Positioning System Having Angular Rate Correction

(71) Applicant: CATERPILLAR INC., Peoria, IL (US)

(72) Inventor: Paul Russell FRIEND, Morton, IL (US)

(73) Assignee: Caterpillar Inc., Peoria, IL (US)

(21) Appl. No.: 13/665,737

(22) Filed: Oct. 31, 2012

(51) Int. Cl. G01C 19/58; G06F 17/00

(52) U.S. Cl. CPC G01C 19/58; G06F 17/00
USPC 702/145

(57) ABSTRACT

A system and method for estimating orientation of a machine is disclosed. The method may include receiving, from a first sensor, a first angular rate of the machine measured in a body reference frame of the machine, and determining an estimated bias for a second sensor of the machine and an uncertainty measure for the estimated bias. The method may further include determining a scale factor based on the uncertainty measure and converting the first angular rate of the machine in the body reference frame to a first angular rate of the machine in a gravity reference frame by utilizing a rotation matrix including the scale factor. The method may further include estimating the orientation of the machine based on the first angular rate of the machine in the gravity reference frame.

### TECHNICAL FIELD

The present disclosure relates generally to a machine positioning system and, more particularly, to a machine positioning system having angular rate correction.

### BACKGROUND

Machines such as, for example, dozers, motor graders, wheel loaders, wheel tractor scrapers, and other types of heavy equipment are used to perform a variety of tasks. Autonomously and semi-autonomously controlled machines are capable of operating with little or no human input by relying on information received from various machine systems. For example, based on machine movement input, terrain input, and/or machine operational input, a machine can be controlled to remotely and/or automatically complete a programmed task. By receiving appropriate feedback from each of the different machine systems during performance of the task, continuous adjustments to machine operation can be made that help to ensure precision and safety in completion of the task. In order to do so, however, the information provided by the different machine systems should be accurate and reliable. The heading (also referred to as “yaw”), roll, and pitch of the machine are parameters whose accuracy may be important for control and positioning of the machine.

Conventional machines typically utilize a positioning system to determine various operating parameters such as velocity, pitch rate, yaw rate, roll rate, etc. The positioning system relies on Global Navigation Satellite System (GNSS) data along with data from an Inertial Measurement Unit (IMU) to calculate the yaw, roll, and pitch of the machine. As an example, a 6-degree of freedom (6 DOF) IMU may be utilized to determine the attitude (orientation) of the machine. A 6 DOF IMU consists of a 3-axis accelerometer, 3-axis angular rate gyros, and sometimes a 2-axis inclinometer. The 3-axis angular rate gyros may be utilized to determine the roll rate, pitch rate, and yaw rate of the machine relative to the earth's gravity when the machine is moving on flat ground. To calculate the roll, pitch, and yaw of the machine, the respective angular rates may be integrated.

However, under dynamic conditions such as when the machine is moving up a hill, the roll, pitch, and yaw calculations may not be accurate because the angular rate gyros make their measurements in the inertial-body reference frame (“body reference frame”) as opposed to the gravity earth-tangent reference frame (“gravity reference frame”). The body reference frame is a reference frame that describes movement relative to itself (the body of the system) in space. The gravity reference frame is a reference frame that describes the position, orientation, and movement relative to the earth's surface. Under dynamic conditions, such as when the machine is moving up a hill, the body reference frame may be different from the gravity reference frame.

An exemplary system used to control a machine is disclosed in U.S. Pat. No. 6,332,103 to Steenson, Jr. et al. (“Steenson, Jr.”) that issued on Dec. 18, 2009. Steenson, Jr. discloses a state estimator that converts rotation rates (for example, a pitch rate) from a vehicle reference frame to an earth reference frame by utilizing other rotation rates (for example, a roll rate and a yaw rate). The state estimator calculates an angle (for example, a pitch) of the machine by integrating the earth reference frame rotation rates.

Although the Steenson, Jr. system may be useful in converting rotation rates from a vehicle reference frame to an earth reference and determining a vehicle orientation from the converted rates, the Steenson, Jr. system may not provide an adequate correction for the angular rates that are determined in the body reference frame. This is because errors in one of the angular rates may result in significant errors in the converted angular rate.

The machine positioning system of the present disclosure is directed toward solving one or more of the problems set forth above and/or other problems of the prior art.

### SUMMARY

In one aspect, the present disclosure is directed to a system for estimating an orientation of a machine. The system may include a first sensor configured to provide a first angular rate of the machine, a second sensor configured to provide a second angular rate of the machine, and a controller in communication with the first sensor and the second sensor. The controller may be configured to detect the first angular rate and determine an estimated bias for the second sensor and an uncertainty measure for the estimated bias. The controller may be further configured to determine a scale factor based on the uncertainty measure, and convert the first angular rate of the machine in a body reference frame to a first angular rate of the machine in a gravity reference frame by utilizing a rotation matrix including the scale factor. The controller may be further configured to estimate the orientation of the machine based on the first angular rate of the machine in the gravity reference frame.

In another aspect, the present disclosure is directed to a method of estimating orientation of a machine. The method may include receiving, from a first sensor, a first angular rate of the machine measured in a body reference frame of the machine, and determining an estimated bias for a second sensor of the machine and an uncertainty measure for the estimated bias. The method may further include determining a scale factor based on the uncertainty measure and converting the first angular rate of the machine in the body reference frame to a first angular rate of the machine in a gravity reference frame by utilizing a rotation matrix including the scale factor. The method may further include estimating the orientation of the machine based on the first angular rate of the machine in the gravity reference frame.

In yet another aspect, the present disclosure is directed to a non-transitory computer-readable storage device configured to store instructions for enabling a processor to execute a method of estimating orientation of a machine. The method may include receiving, from a first sensor, a first angular rate of the machine measured in a body reference frame of the machine, and determining an estimated bias for a second sensor of the machine and an uncertainty measure for the estimated bias. The method may further include determining a scale factor based on the uncertainty measure and converting the first angular rate of the machine in the body reference frame to a first angular rate of the machine in a gravity reference frame by utilizing a rotation matrix including the scale factor. The method may further include estimating the orientation of the machine based on the first angular rate of the machine in the gravity reference frame.

### BRIEF DESCRIPTION OF THE DRAWINGS

FIG. 1 is a pictorial illustration of an exemplary disclosed machine;

FIG. 2 is a diagrammatic illustration of an exemplary disclosed positioning system that may be used in conjunction with the machine of FIG. 1;

FIG. 3 is a diagrammatic illustration of an exemplary processor in the disclosed positioning system of FIG. 2; and

FIG. 4 is a flowchart depicting an exemplary disclosed method performed by the positioning system of FIG. 2.

### DETAILED DESCRIPTION

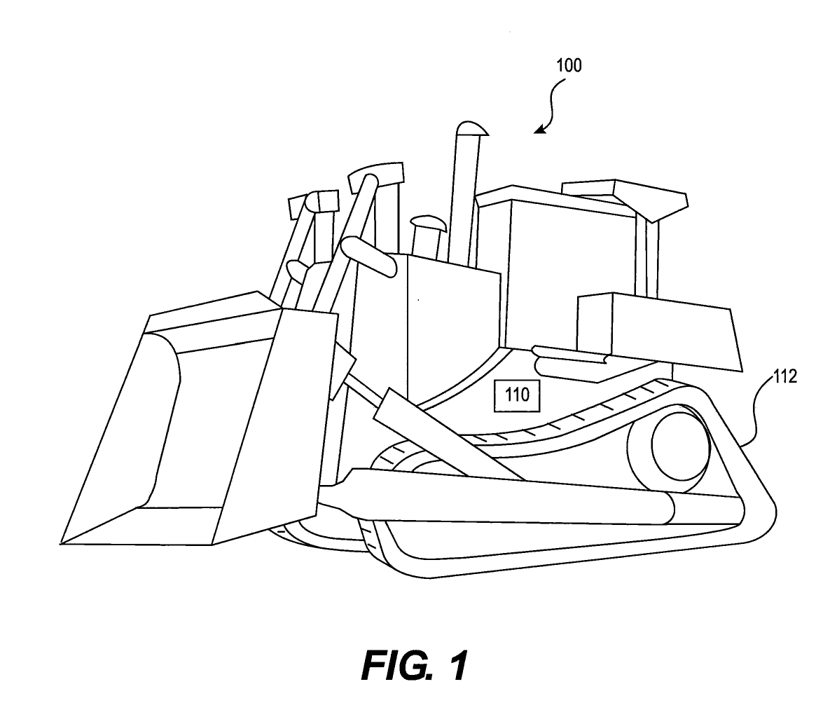

FIG. 1 illustrates a machine 100 having an exemplary disclosed positioning system 110. The machine 100 may be configured to perform some type of operation associated with an industry such as mining, construction, farming, transportation, power generation, or any other industry known in the art. For example, machine 100 may be an earth moving machine such as a haul truck, a dozer, a loader, a backhoe, an excavator, a motor grader, a wheel tractor scraper or any other earth moving machine. Machine 100 may generally include a frame that at least partially defines or supports an operator station, one or more engines mounted to the frame, a plurality of traction devices 112 driven by the engine to propel machine 100. The traction devices 112, in the disclosed exemplary embodiments, are tracks located at opposing sides of machine 100. Each track may be independently driven to turn machine 100 or simultaneously and dependently driven to propel machine 100 in a straight direction. It is contemplated that one or all of traction devices 112 may be replaced with another type of traction device, if desired, such as belts or wheels.

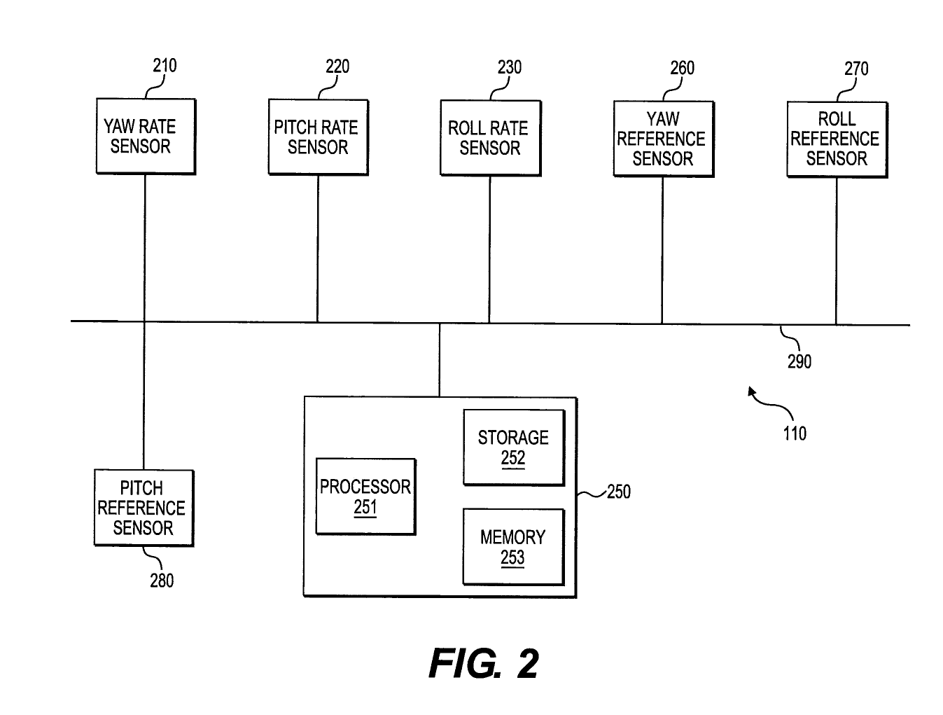

FIG. 2 illustrates an exemplary embodiment of positioning system 110. Positioning system 110 may include a yaw rate sensor 210, a pitch rate sensor 220, a roll rate sensor 230, a controller 250, a yaw reference sensor 260, a roll reference sensor 270, and a pitch reference sensor 280. The above sensors and the controller 250 may be connected to each other via a bus 290. While a bus architecture is shown in FIG. 2, any suitable architecture may be used, including any combination of wired and/or wireless networks. Additionally, such networks may be integrated into any local area network, wide area network, and/or the Internet.

The yaw rate sensor 210 may include any device (such as a gyroscope) capable of measuring a yaw rate of the machine 100, and producing a corresponding yaw rate signal. The pitch rate sensor 220 may include any device (such as a gyroscope) capable of measuring a pitch rate of the machine 100, and producing a corresponding pitch rate signal. The roll rate sensor 230 may include any device (such as a gyroscope) capable of measuring a roll rate of the machine 100, and producing a corresponding roll rate signal. Exemplarily, the yaw rate sensor 210, the pitch rate sensor 220, and the roll rate sensor 230 may be part of a single IMU including 3-axis angular rate gyros that provide signals indicative of the pitch rate, yaw rate, and roll rate of the machine 100. According to other embodiments, each of the yaw rate sensor 210, the pitch rate sensor 220, and the roll rate sensor 230 may be part of separate IMUs.

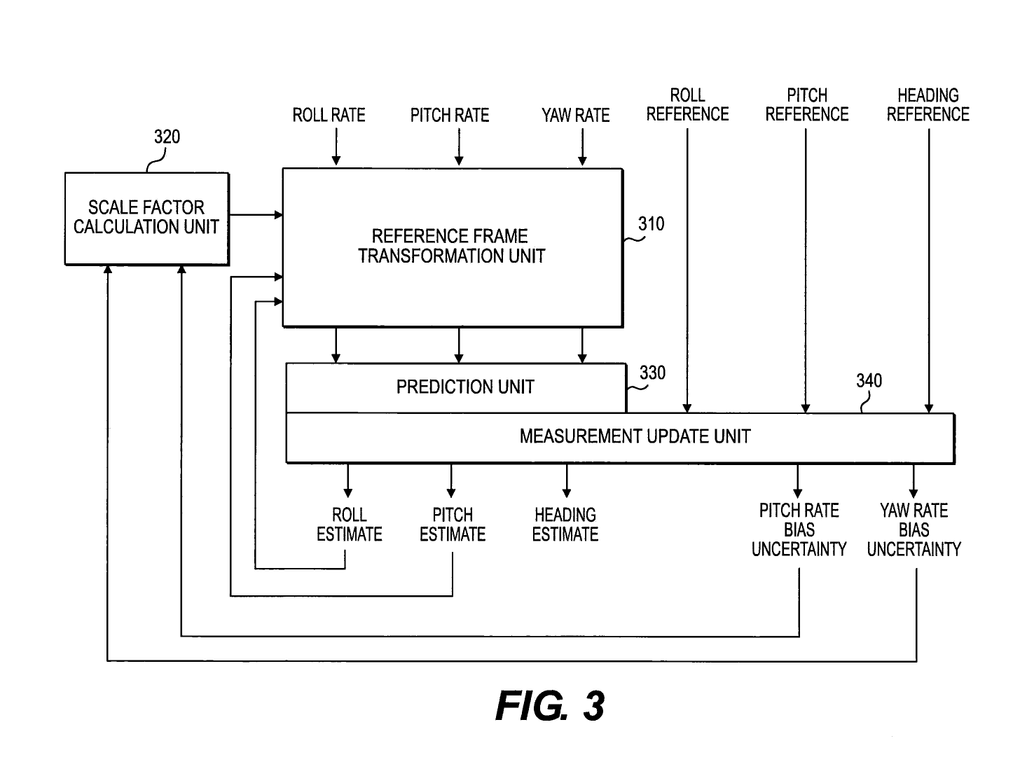

The controller 250 may include a processor 251, a storage 252, and a memory 253 assembled together in a single device and/or provided separately. Processor 251 may include one or more known processing devices, such as a microprocessor from the Pentium™ or Xeon™ family manufactured by Intel™, the Turion™ family manufactured by AMD™, any of various processors manufactured by Sun Microsystems, or any other type of processor. The memory 253 may include one or more storage devices configured to store information used by the controller 250 to perform certain functions related to disclosed embodiments. The storage 252 may include a volatile or non-volatile, magnetic, semiconductor, tape, optical, removable, nonremovable, or other type of storage device or computer-readable medium. The storage 252 may store programs and/or other information, such as information related to processing data received from one or more sensors, as discussed in greater detail below. The controller 250, and more particularly the processor 251, is described in greater detail with reference to FIG. 3.

The yaw reference sensor 260 may include any device capable of providing a heading reference by measuring the yaw (heading) of the machine 100 and providing a heading measurement. Alternatively, the yaw reference sensor 260 may include any device capable of providing the heading reference by generating a signal indicative of heading that can be processed by the controller 250 to obtain heading of the machine 100. In an exemplary embodiment, the yaw reference sensor 260 may include a single Global Positioning System (GPS) receiver, a dual GPS system or a magnetic compass. In another exemplary embodiment, the yaw reference sensor 260 may include a differential fraction device speed sensor that measures a differential traction device speed between left and right traction devices 112 of the machine 100. Any device capable of providing a heading measurement may be included in the yaw reference sensor 260.

The roll reference sensor 270 may include any device capable of providing a roll reference by measuring the roll of the machine 100 and providing a roll measurement in the gravity reference frame. Alternatively, the roll reference sensor 270 may include any device capable of providing the roll reference by generating a signal indicative of the roll in the gravity reference frame that can be processed by the controller 250 to obtain the roll in the gravity reference frame. In an exemplary embodiment, the roll reference sensor 270 may include an inclinometer or an accelerometer. In another exemplary embodiment, the roll reference sensor 270 may include a side-by-side dual GPS system or any other device that can provide information on the roll of the machine 100 in the gravity reference frame.

The pitch reference sensor 280 may include any device capable of providing a pitch reference by measuring the pitch of the machine 100 and providing a pitch measurement in the gravity reference frame. Alternatively, the pitch reference sensor 280 may include any device capable of providing the pitch reference by generating a signal indicative of the pitch in the gravity reference frame that can be processed by the controller 250 to obtain the pitch in the gravity reference frame. In an exemplary embodiment, the pitch reference sensor 280 may include an inclinometer. In another exemplary embodiment, the pitch reference sensor 280 may include an accelerometer. In yet another exemplary embodiment, the pitch reference sensor 280 may include a front-back dual GPS system or any other device that can provide information on the pitch of the machine 100.

In one exemplary embodiment, the memory 253 may include one or more angle detection programs or subprograms loaded from the storage 252 or elsewhere that, when executed by the processor 251, perform various procedures, operations, or processes consistent with disclosed embodiments. For example, the memory 253 may include one or more programs that enable the controller 250 to, among other things, collect data from the above-mentioned sensors and process the data according to disclosed embodiments such as those embodiments discussed next with regard to FIG. 3, and determine an orientation of the machine 100, for example, pitch, yaw, and roll of the machine 100, based on the processed data.

FIG. 3 illustrates an exemplary embodiment of the controller 250, and more particularly of the processor 251. The controller 250 may include a reference frame transformation unit 310, a scale factor calculation unit 320, a prediction unit 330, and a measurement update unit 340. Although the components included in the controller 250 are shown as separate components, they may be implemented in any combination of hardware and/or software. For example, in one embodiment, the components in the controller 250 shown in FIG. 3 may be implemented in the form of software stored on one or more of the storage 252 and/or the memory 253 that, when executed by the processor 251, enable the controller 250 to perform functions related to disclosed embodiments.

The reference frame transformation unit 310 may be configured to implement a rotation matrix that converts angular rates measured in the body reference frame to angular rates in the gravity reference frame. The reference frame transformation unit 310 may receive the roll rate from the roll rate sensor 230, the pitch rate from the pitch rate sensor 220, and the yaw rate from the yaw rate sensor 210. Each of these rates may be measured by the respective sensors in the body reference frame of the machine 100. To convert the angular rates (for example, the received yaw rate, the received roll rate, the received pitch rate) into respective angular rates in the gravity reference frame, the following rotation matrix may be utilized:

$$[ \begin{matrix}1 & {\dot{θ}}_{SCALE} ( sin φtan θ ) & {\dot{ψ}}_{SCALE} ( cos φtan θ ) \\ 0 & cos φ & {\dot{ψ}}_{SCALE} ( - sin φ ) \\ 0 & {\dot{θ}}_{SCALE} ( \frac{sin φ}{cos θ} ) & \frac{cos φ}{cos θ}\end{matrix} ] \qquad ( 1 )$$

In particular, the angular rates in the gravity reference frame may be calculated by using the rotation matrix of (1) in the following equation:

$$[ \begin{matrix}\dot{ϕ} \\ \dot{θ} \\ \dot{ψ}\end{matrix} ] = [ \begin{matrix}1 & {\dot{θ}}_{SCALE} ( sin φtan θ ) & {\dot{ψ}}_{SCALE} ( cos φtan θ ) \\ 0 & cos φ & {\dot{ψ}}_{SCALE} ( - sin φ ) \\ 0 & {\dot{θ}}_{SCALE} ( \frac{sin φ}{cos θ} ) & \frac{cos φ}{cos θ}\end{matrix} ] [ \begin{matrix}\dot{{ϕ}_{B}} \\ \dot{{θ}_{B}} \\ \dot{{ψ}_{B}}\end{matrix} ] \qquad ( 2 )$$

In equation (2) above, \dot{φ}_{B} corresponds to the roll rate received from the roll rate sensor 230; \dot{θ}_{B} corresponds to the pitch rate received from the pitch rate sensor 220; and \dot{ψ}_{B} corresponds to the yaw rate received from the yaw rate sensor 210. The subscript “B” indicates that these angular rates are measured in the body reference frame. The outputs of equation (2) are angular rates (roll rate \dot{φ}, the pitch rate \dot{θ}, and the yaw rate \dot{ψ}) in the gravity reference frame.

Inside the rotation matrix, φ corresponds to an estimate of the roll of the machine 100, and θ corresponds to an estimate of the pitch of the machine 100. Both the roll and pitch estimates are estimates of roll and pitch from the preceding calculation cycle. In some calculation cycles, the roll and pitch estimates may be output by the measurement update unit 340. In other calculation cycles, the roll and pitch estimates may be output by the prediction unit 330.

The rotation matrix also includes scale factors \dot{θ}_{SCALE} and \dot{ψ}_{SCALE} that are determined by the scale factor calculation unit 320. These scale factors are included in the rotation matrix to account for any uncertainty in the angular rate biases estimated by the prediction unit 330 and the measurement update unit 340. This is because, when the angular rate biases are incorrectly estimated by the prediction unit 330 or the measurement update unit 340, the transformation of the angular rates by the rotation matrix may degrade the system performance. The estimated angular rate biases provide an estimate of bias or drift in the angular rate sensors (for example, yaw rate sensor 210, pitch rate sensor 220, or roll rate sensor 230) and may be calculated by the prediction unit 330 and the measurement update unit 340 when they calculate the corresponding orientation estimate. Exemplary operations of the scale factor calculation unit 320 will be discussed next.

The scale factors \dot{θ}_{SCALE} and \dot{ψ}_{SCALE} may be calculated based on a goal bias uncertainty estimate. For example, a bias goal β_{GOAL} of 0.00075 deg/sec (2.7 deg/hr) may be utilized and the scale factors \dot{θ}_{SCALE} and \dot{ψ}_{SCALE} may be calculated as follows:

$$\begin{matrix}{\dot{θ}}_{SCALE} = \frac{{β}_{GOAL}}{{\hat{β}}_{σθ}} [ LIMIT ( 0 , + 1 ) ] = \frac{0.00075}{{\hat{β}}_{σθ}} [ LIMIT ( 0 , + 1 ) ] & ( 3 ) \\ {\dot{ψ}}_{SCALE} = \frac{{β}_{GOAL}}{{\hat{β}}_{σψ}} [ LIMIT ( 0 , + 1 ) ] = \frac{0.00075}{{\hat{β}}_{σψ}} [ LIMIT ( 0 , + 1 ) ] & ( 4 )\end{matrix}$$

In the above equations, \hat{β}_{σθ} and \hat{β}_{σψ} may correspond to an estimated uncertainty value associated with respective angular rate biases. Exemplarily, \hat{β}_{σθ} and \hat{β}_{σψ} may correspond to an estimated uncertainty value from an error covariance matrix of a Kalman filter. In an exemplary embodiment, \hat{β}_{σθ} and \hat{β}_{σψ} may correspond to the estimated bias uncertainty value P11 (described later) calculated by either the prediction unit 330 or the measurement update unit 340. For example, \hat{β}_{σψ} may correspond to the uncertainty value P11 for the yaw rate bias estimate calculated by the prediction unit 330 or the measurement update unit 340, depending on whether the orientation estimates (roll and pitch estimates) used in the rotation matrix are received from the prediction unit 330 or the measurement update unit 340. For example, if the orientation estimates (roll and pitch estimates) used in the rotation matrix are received from the prediction unit 330, the scale factor calculation unit 320 may utilize the P11 value for the yaw rate bias estimate calculated by the prediction unit 330. Similarly, \hat{β}_{σθ} may correspond to the uncertainty value P11 for the pitch rate bias estimate calculated by the prediction unit 330 or the measurement update unit 340. A detailed explanation regarding the calculation of the uncertainty values P11 will be described below along with description of the operation of the measurement update unit 340. While equations (3) and (4) state as an example, a bias goal β_{GOAL} of 0.00075 deg/sec (2.7 deg/hr), a skilled artisan may utilize various other bias goal values depending on the design and desired performance of the implemented system.

As indicated in equations (3) and (4), the scale factors \dot{θ}_{SCALE} and \dot{ψ}_{SCALE} may not assume values beyond ‘0’ and ‘+1.’ For example, if equation (3) resulted in the value of the scale factor \dot{θ}_{SCALE} of 1.22, the scale factor \dot{θ}_{SCALE} may be limited to ‘+1.’ Similarly, if the value of the scale factor \dot{θ}_{SCALE} was calculated to be below zero, the value may be limited to zero. The limits of the scale factor may be adjusted by a skilled artisan according to the design needs of the implemented system.

According to another exemplary embodiment, the scale factors \dot{θ}_{SCALE} and \dot{ψ}_{SCALE} may be determined by a threshold comparison. For example, an estimated uncertainty value associated with respective angular rate biases may be compared against a threshold to determine the scale factors. Exemplarily, estimated uncertainty values from the error covariance matrix of a Kalman filter may be compared against a threshold to determine the scale factors. For example, the estimated bias uncertainty value P11 for the estimated yaw rate bias and the estimated pitch rate bias may be compared against a threshold. Exemplarily, a bias uncertainty threshold of 0.001 deg/sec or (3.5 deg/hr) may be used. If the estimated bias uncertainty value P11 is less than or equal to 0.001, then the corresponding scale factor may be set to a ‘1’, and if it is greater than 0.001 the scale factor may be set to a ‘0.’ For example, if the uncertainty value P11 for the yaw rate bias estimate calculated by the prediction unit 330 or the measurement update unit 340 is less than or equal to 0.001, then \dot{ψ}_{SCALE} may be set to a ‘1’, and if it is greater than 0.001 \dot{ψ}_{SCALE} may be set to a ‘0.’ Similarly, if the uncertainty value P11 for the pitch rate bias estimate calculated by the prediction unit 330 or the measurement update unit 340 is less than or equal to 0.001, then \dot{θ}_{SCALE} may be set to a ‘1’, and if it is greater than 0.001 \dot{θ}_{SCALE} may be set to a ‘0.’ It will be understood that limits ‘1’ and ‘0’ are provided as exemplary limits, and a skilled artisan may adjust these limits based on the specific design of the implemented system.

After converting the body angular rates \dot{φ}_{B}, \dot{θ}_{B}, and \dot{ψ}_{B} to roll rate \dot{φ}, pitch rate \dot{θ}, and yaw rate \dot{ψ}, respectively, in the gravity reference frame, the reference frame transformation unit 310 may provide the gravity reference frame angular rates (roll rate \dot{φ}, pitch rate \dot{θ}, yaw rate \dot{ψ}) to the prediction unit 330. In certain embodiments, the memory 253 may store program enabling instructions that configure the controller 250 to implement a method that uses a Kalman filter to estimate the yaw, roll, and pitch of the machine 100 by utilizing the gravity reference frame angular rates. In FIG. 3, the prediction unit 330 and the measurement update unit 340 may implement a Kalman filter.

A Kalman filter is a mathematical method that may be used to determine accurate values of measurements observed over time, such as measurements taken in a time series. The Kalman filter's general operation involves two phases, a propagation or “predict” phase and a measurement or “update” phase. In the predict phase, the value estimate from the previous timestep in the time series is used to generate an a priori value estimate. In the update phase, the a priori estimate calculated in the predict phase is combined with an estimate of the accuracy (e.g., the variance) of the a priori estimate, and a current measurement value to produce a refined a posteriori estimate. In the controller 250, the prediction unit 330 may implement the “predict” phase of the Kalman filter and the measurement update unit 340 may implement the “update” phase of the Kalman filter. Exemplary equations that may be utilized by the prediction unit 330 and measurement update unit 340 are described below.

For the propagation or “predict” phase, the prediction unit 330 may be configured to utilize the following generic equations:

\hat{x}ₖ⁻=Fₖ₋₁\hat{x}ₖ₋₁+Gₖ₋₁uₖ₋₁ (5)

Pₖ⁻=Fₖ₋₁Pₖ₋₁⁺Fₖ₋₁^{T}+Qₖ₋₁ (6)

For the measurement or “update” phase, the measurement update unit 340 may be configured to utilize the following generic equations:

Kₖ=Pₖ₋₁⁻H^{T}(HₖPₖ₋₁⁻Hₖ^{T}+Rₖ)⁻¹ (7)

\hat{x}ₖ⁺=\hat{x}ₖ⁻+Kₖ(yₖ−Hₖ\hat{x}ₖ⁻) (8)

Pₖ⁺=(I−KₖHₖ)Pₖ⁻ (9)

The prediction unit 330 and the measurement update unit 340 may be configured to utilize equations (5)-(9) to separately calculate an estimate for the yaw, pitch, and roll of the machine 100.

For example, the following state transition matrices may be utilized with equations (5)-(9) to calculate an estimate of the heading of the machine 100:

$$\begin{matrix}{x}_{k} = [ \begin{matrix}1 & - dt \\ 0 & 1\end{matrix} ] [ \begin{matrix}ψ \\ {\dot{ψ}}_{BIAS}\end{matrix} ] + [ \begin{matrix}dt \\ 0\end{matrix} ] [ \dot{ψ} ] + {w}_{k - 1} & ( 10 ) \\ yk = [ \begin{matrix}1 & 0\end{matrix} ] [ \begin{matrix}ψ \\ {\dot{ψ}}_{BIAS}\end{matrix} ] + {v}_{k} & ( 11 )\end{matrix}$$

Further, the following state transition matrices may be utilized with equations (5)-(9) to calculate an estimate of the pitch of the machine 100:

$$\begin{matrix}{x}_{k} = [ \begin{matrix}1 & - dt \\ 0 & 1\end{matrix} ] [ \begin{matrix}θ \\ {\dot{θ}}_{BIAS}\end{matrix} ] + [ \begin{matrix}dt \\ 0\end{matrix} ] [ \dot{θ} ] + {w}_{k - 1} & ( 12 ) \\ yk = [ \begin{matrix}1 & 0\end{matrix} ] [ \begin{matrix}θ \\ {\dot{θ}}_{BIAS}\end{matrix} ] + {v}_{k} & ( 13 )\end{matrix}$$

Further, the following state transition matrices may be utilized with equations (5)-(9) to calculate an estimate of the roll of the machine 100:

$$\begin{matrix}{x}_{k} = [ \begin{matrix}1 & - dt \\ 0 & 1\end{matrix} ] [ \begin{matrix}ϕ \\ {\dot{ϕ}}_{BIAS}\end{matrix} ] + [ \begin{matrix}dt \\ 0\end{matrix} ] [ \dot{ϕ} ] + {w}_{k - 1} & ( 10 ) \\ yk = [ \begin{matrix}1 & 0\end{matrix} ] [ \begin{matrix}ϕ \\ {\dot{ϕ}}_{BIAS}\end{matrix} ] + {v}_{k} & ( 11 )\end{matrix}$$

Further in equations (5)-(9), Q is the process noise matrix, w is the process noise, and v is the measurement noise. Also, in equations (5)-(9),

$$F = [ \begin{matrix}1 & - dt \\ 0 & 1\end{matrix} ]$$

$$G = [ \begin{matrix}dt \\ 0\end{matrix} ]$$

$$H = [ \begin{matrix}1 & 0\end{matrix} ]$$

Additionally, P in equations (5)-(9) may be a 2×2 error covariance matrix, which represents an estimation of the error or uncertainty in the values estimated by the prediction unit 330 and the measurement update unit 340.

$$P = [ \begin{matrix}P 00 & P 01 \\ P 10 & P 11\end{matrix} ]$$

Exemplarily, in the above P matrix, P00 may correspond to a square of the orientation estimate (for example, yaw, roll, and pitch) uncertainty and P11 may correspond to a square of the corresponding angular rate bias error. That is, P11 may be a measure of the uncertainty or error in the estimated angular rate bias or bias of the corresponding angular rate sensor. According to one exemplary embodiment, P00 may be initialized at startup to 360²=129600 degrees and P11 may be initialized at startup to the square of the maximum bias error as specified by the manufacturer of the angular rate sensor (for example, yaw rate sensor 210, pitch rate sensor 220, and roll rate sensor 230). P01 and P10 may be initialized to zero at startup. Next, a detailed description is provided for calculation of each of the orientation estimates and corresponding bias estimates by the prediction unit 330 and the measurement update unit 340, beginning with estimation of heading and yaw rate bias.

The prediction unit 330 may calculate an a priori estimated heading of the machine 100 based on a previously estimated heading. For example, the prediction unit 330 may receive a heading and a yaw rate bias estimate calculated in an immediately preceding timestep. The prediction unit 330 may also receive a yaw rate value, e.g., \dot{ψ} from the reference frame transformation unit 310. The prediction unit 330 may then use the received data to calculate an a priori estimated heading of the machine 100 using equations (5) and (10). For example, the prediction unit 330 may set ψ=the previously estimated heading, \dot{ψ}_{BIAS}=the previously estimated yaw rate bias, and \dot{ψ}=the gravity reference frame yaw rate value received from the reference frame transformation unit 310, in equation (10) to calculate the a priori state estimate \hat{x}ₖ⁻, which is a combination of the a priori estimated heading and the a priori yaw rate bias estimate.

The above calculation for the a priori state estimate \hat{x}ₖ⁻ may be performed in the propagation or “predict” phase. In the “predict” phase, the prediction unit 330 may also calculate an a priori estimate error covariance Pₖ⁻ using equation (6). Exemplarily, Pₖ⁻ may provide the P11 value for the scale factor calculation unit 320 in certain calculation cycles to calculate \dot{ψ}_{SCALE}.

The measurement update unit 340, which may implement the measurement or “update” phase of the Kalman filter, may calculate an a posteriori yaw rate bias estimate for the yaw rate sensor 210 and an a posteriori estimated heading using equations (7), (8), (9), and (11). To perform these calculations, the measurement update unit 340 may utilize a heading measurement. Exemplarily, the heading measurement may be calculated based on the heading reference received from the yaw reference sensor 260. For example, the measurement update unit 340 may receive, as the heading reference, a signal indicative of the heading (for example, from a single GPS receiver, a dual GPS system, a magnetic compass, a differential traction device speed sensor) and calculate a heading measurement from the received heading reference.

Next, the measurement update unit 340 may calculate the Kalman gain Kₖ utilizing equation (7). In equation (7), Pₖ₋₁⁻ refers to the a priori estimate error covariance from the previous timestep and Rₖ refers to the variance for the corresponding heading measurement. Having calculated the Kalman gain, the measurement update unit 340 may determine a measurement yₖ utilizing equation (11), where the heading measurement may be set as ψ. Utilizing the a priori estimate \hat{x}ₖ⁻ from the “predict” phase, measurement yₖ, and the Kalman gain Kₖ, the measurement update unit 340 may calculate the a posteriori state estimate \hat{x}ₖ⁺ utilizing equation (8). The a posteriori state estimate \hat{x}ₖ⁺ provides the a posteriori estimated heading of the machine 100 as well as the a posteriori yaw rate bias estimate for the yaw rate sensor 210. At this time, the measurement update unit 340 may also calculate the a posteriori estimate error covariance Pₖ⁺ by utilizing equation (9). In equation (9), I refers to the identity matrix and Pₖ⁻ refers to the a priori estimate error covariance from the “predict” phase. Exemplarily, Pₖ⁺ may provide the P11 value for the scale factor calculation unit 320 in certain calculation cycles to calculate \dot{ψ}_{SCALE}.

The prediction unit 330 may also calculate estimates for the pitch of machine 100. For example, the prediction unit 330 may calculate an a priori estimated pitch of the machine 100 based on a previously estimated pitch. Exemplarily, the prediction unit 330 may receive a pitch and a pitch rate bias estimate calculated in an immediately preceding timestep. The prediction unit 330 may also receive a pitch rate value, e.g., \dot{θ} from the reference frame transformation unit 310. The prediction unit 330 may then use the received data to calculate an a priori estimated pitch of the machine 100 using equations (5) and (12). For example, the prediction unit 330 may set θ=the previously estimated pitch, \dot{θ}_{BIAS} the previously estimated pitch rate bias, and \dot{θ}=the gravity reference frame pitch rate value received from the reference frame transformation unit 310, in equation (12) to calculate the a priori state estimate \hat{x}ₖ⁻, which is a combination of the a priori estimated pitch and the a priori pitch rate bias estimate.

The above calculation for the a priori state estimate \hat{x}ₖ⁻ may be performed in the propagation or “predict” phase. In the “predict” phase, the prediction unit 330 may also calculate an a priori estimate error covariance Pₖ⁻ using equation (6). Exemplarily, Pₖ⁻ may provide the P11 value for the scale factor calculation unit 320 in certain calculation cycles to calculate \dot{θ}_{SCALE}.

The measurement update unit 340, which may implement the measurement or “update” phase of the Kalman filter, may calculate an a posteriori pitch rate bias estimate for the pitch rate sensor 220 and an a posteriori estimated pitch using equations (7), (8), (9), and (13). To perform these calculations, the measurement update unit 340 may utilize a pitch measurement. Exemplarily, the pitch measurement may be calculated based on the pitch reference received from the pitch reference sensor 280. For example, the measurement update unit 340 may receive, as the pitch reference, a signal indicative of the pitch and calculate a pitch measurement from the received pitch reference. The measurement update unit 340 may filter the received pitch reference to remove non-gravity components prior to calculating the pitch measurement from the received pitch reference.

Next, the measurement update unit 340 may calculate the Kalman gain Kₖ utilizing equation (7). In equation (7), Pₖ₋₁⁻ refers to the a priori estimate error covariance from the previous timestep and Rₖ refers to the variance for the corresponding pitch measurement. Having calculated the Kalman gain, the measurement update unit 340 may determine a measurement yₖ utilizing equation (13), where the calculated pitch measurement may be set as θ. Utilizing the a priori estimate \hat{x}ₖ⁻ from the “predict” phase, measurement yₖ, and the Kalman gain Kₖ, the measurement update unit 340 may calculate the a posteriori state estimate \hat{x}ₖ⁺ utilizing equation (8). The a posteriori state estimate \hat{x}ₖ⁺ provides the a posteriori estimated pitch of the machine 100 as well as the a posteriori pitch rate bias estimate for the pitch rate sensor 220. At this time, the measurement update unit 340 may also calculate the a posteriori estimate error covariance Pₖ⁺ by utilizing equation (9). In equation (9), I refers to the identity matrix and Pₖ⁻ refers to the a priori estimate error covariance from the “predict” phase. Exemplarily, Pₖ⁻ may provide the P11 value for the scale factor calculation unit 320 in certain calculation cycles to calculate \dot{θ}_{SCALE}.

The prediction unit 330 may also calculate estimates for the roll of machine 100. For example, the prediction unit 330 may calculate an a priori estimated roll of the machine 100 based on a previously estimated roll. Exemplarily, the prediction unit 330 may receive a roll and a roll rate bias estimate calculated in an immediately preceding timestep. The prediction unit 330 may also receive a roll rate value, e.g., \dot{φ} from the reference frame transformation unit 310. The prediction unit 330 may then use the received data to calculate an a priori estimated roll of the machine 100 using equations (5) and (14). For example, the prediction unit 330 may set φ=the previously estimated roll, \dot{φ}_{BIAS} the previously estimated roll rate bias, and \dot{φ}=the gravity reference frame roll rate value received from the reference frame transformation unit 310, in equation (14) to calculate the a priori state estimate \hat{x}ₖ⁻, which is a combination of the a priori estimated roll and the a priori roll rate bias estimate.

The above calculation for the a priori state estimate \hat{x}ₖ⁻ may be performed in the propagation or “predict” phase. In the “predict” phase, the prediction unit 330 may also calculate an a priori estimate error covariance Pₖ⁻ using equation (6).

The measurement update unit 340, which may implement the measurement or “update” phase of the Kalman filter, may calculate an a posteriori roll rate bias estimate for the roll rate sensor 230 and an a posteriori estimated pitch using equations (7), (8), (9), and (15). To perform these calculations, the measurement update unit 340 may utilize a roll measurement. Exemplarily, the roll measurement may be calculated based on the roll reference received from the roll reference sensor 270. For example, the measurement update unit 340 may receive, as the roll reference, a signal indicative of the roll and calculate a roll measurement from the received roll reference. The measurement update unit 340 may filter the received roll reference to remove non-gravity components prior to calculating the roll measurement from the received roll reference.

Next, the measurement update unit 340 may calculate the Kalman gain Kₖ utilizing equation (7). In equation (7), Pₖ₋₁⁻ refers to the a priori estimate error covariance from the previous timestep and Rₖ refers to the variance for the corresponding roll measurement. Having calculated the Kalman gain, the measurement update unit 340 may determine a measurement yₖ utilizing equation (15), where the calculated roll measurement may be set as φ. Utilizing the a priori estimate \hat{x}ₖ⁻ from the “predict” phase, measurement yₖ, and the Kalman gain Kₖ, the measurement update unit 340 may calculate the a posteriori state estimate \hat{x}ₖ⁺ utilizing equation (8). The a posteriori state estimate \hat{x}ₖ⁺ provides the a posteriori estimated roll of the machine 100 as well as the a posteriori roll rate bias estimate for the roll rate sensor 230. At this time, the measurement update unit 340 may also calculate the a posteriori estimate error covariance Pₖ⁺ by utilizing equation (9). In equation (9), I refers to the identity matrix and Pₖ⁻ refers to the a priori estimate error covariance from the “predict” phase.

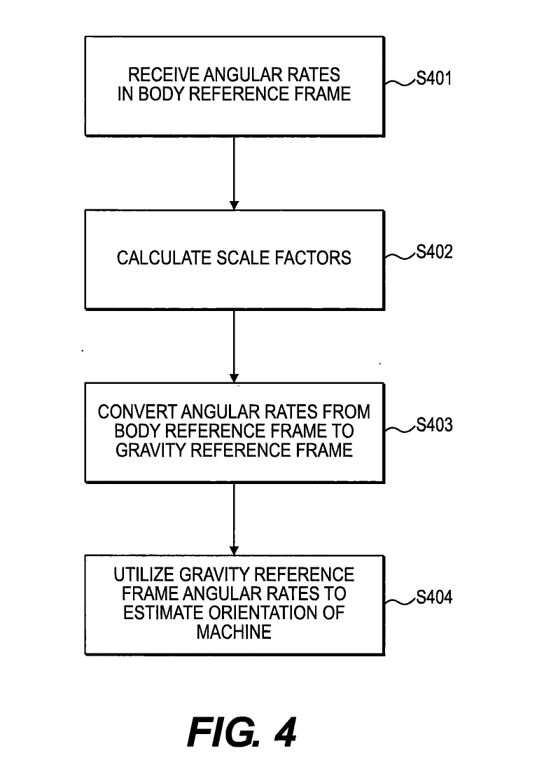

FIG. 4 is an exemplary process implemented by the controller 250 to estimate an orientation of the machine 100. A detailed description of FIG. 4 is provided in the next section.

### INDUSTRIAL APPLICABILITY

The disclosed positioning system 110 may be applicable to any machine where accurate detection of the machine's orientation is desired. The disclosed heading estimation system may provide for improved detection of a machine's orientation by converting angular rates from the machine 100's body reference frame to a gravity reference frame. Operation of the positioning system 110 will now be described in connection with the flowchart of FIG. 4.

In step 401, the controller 250 may receive angular rates from the angular rate sensors (for example, from yaw rate sensor 210, pitch rate sensor 220, or roll rate sensor 230). Each of these rates may be measured by the respective sensors in the body reference frame of the machine 100. Exemplarily, the received angular rates may be provided to the reference frame transformation unit 310.

Next, in step 402, scale factors may be calculated by the controller 250. Exemplarily, the scale factors may be determined by the scale factor calculation unit 320 as discussed above. The scale factor calculation unit 320 may receive estimated bias uncertainty values P11 for the yaw rate bias and the pitch rate bias, and calculate scale factors \dot{θ}_{SCALE} and \dot{ψ}_{SCALE} as discussed above.

Next, in step 403, the controller 250 may convert the angular rates from the body reference frame to the gravity reference frame. Exemplarily, the reference frame transformation unit 310 may be configured to implement a rotation matrix that converts angular rates measured in the body reference frame to angular rates in the gravity reference frame. As discussed above, the reference frame transformation unit 310 may utilize the scale factors calculated by scale factor calculation unit 320 and equations (1) and (2) to calculate angular rates in the gravity reference frame.

In step 404, the controller 250 may utilize the gravity reference frame angular rates to estimate an orientation of the machine 100. For example, the controller 250 may utilize a Kalman filter to estimate the yaw, roll, and pitch of the machine 100 by utilizing the gravity reference frame angular rates. As discussed above, the prediction unit 330 and the measurement update unit 340 may implement a Kalman filter.

The process may continue to repeat in this manner until receiving instructions to stop or until new data ceases to be collected from the machine 100.

The disclosed exemplary embodiments may allow for accurate calculation of the orientation of the machine 100. For example, by converting angular rates measured in the body reference frame to angular rates in the gravity reference frame, an accurate calculation of the orientation of the machine 100 may be possible. By providing the scale factors, the conversion may become more accurate because the scale factor diminishes the contribution of an inaccurately determined angular rate in the rotation matrix.

It will be apparent to those skilled in the art that various modifications and variations can be made to the disclosed positioning system. Other embodiments will be apparent to those skilled in the art from consideration of the specification and practice of the disclosed positioning system. It is intended that the specification and examples be considered as exemplary only, with a true scope being indicated by the following claims and their equivalents.

What is claimed is:

1. A method of estimating an orientation of a machine, comprising:
receiving, from a first sensor, a first angular rate of the machine measured in a body reference frame of the machine;
determining an estimated bias for a second sensor of the machine and an uncertainty measure for the estimated bias;
determining a scale factor based on the uncertainty measure;
converting the first angular rate of the machine in the body reference frame to a first angular rate of the machine in a gravity reference frame by utilizing a rotation matrix including the scale factor; and
estimating the orientation of the machine based on the first angular rate of the machine in the gravity reference frame.

2. The method of claim 1, wherein the first angular rate is one of a pitch rate, a roll rate, and a yaw rate of the machine.

3. The method of claim 1, wherein the second sensor is one of a pitch rate sensor and a yaw rate sensor.

4. The method of claim 1, wherein the rotation matrix further includes a previously estimated orientation of the machine.

5. The method of claim 1, wherein determining the estimated bias for the second sensor of the machine and the uncertainty measure for the estimated bias includes using a Kalman filter.

6. The method of claim 1, wherein determining the scale factor based on the uncertainty measure includes dividing a predetermined goal bias uncertainty value by the uncertainty measure and setting a result of the division as the scale factor.

7. The method of claim 1, wherein determining the scale factor based on the uncertainty measure includes:
comparing the uncertainty measure with a threshold bias uncertainty value;
setting the scale factor equal to a predetermined first value if the uncertainty measure is greater than the threshold bias uncertainty value; and
setting the scale factor equal to a predetermined second value if the uncertainty measure is less than or equal to the threshold bias uncertainty value.

8. A system for estimating an orientation of a machine, comprising:
a first sensor configured to provide a first angular rate of the machine;
a second sensor configured to provide a second angular rate of the machine; and
a controller in communication with the first sensor and the second sensor, the controller configured to:
determine an estimated bias for the second sensor and an uncertainty measure for the estimated bias;
determine a scale factor based on the uncertainty measure;
convert the first angular rate of the machine in a body reference frame to a first angular rate of the machine in a gravity reference frame by utilizing a rotation matrix including the scale factor; and
estimate the orientation of the machine based on the first angular rate of the machine in the gravity reference frame.

9. The system of claim 8, wherein the first angular rate is one of a pitch rate, a roll rate, and a yaw rate of the machine.

10. The system of claim 8, wherein the second sensor is one of a pitch rate sensor and a yaw rate sensor.

11. The system of claim 8, wherein the rotation matrix further includes a previously estimated orientation of the machine.

12. The system of claim 8, wherein the controller is configured to determine the estimated bias for the second sensor of the machine and the uncertainty measure for the estimated bias by using a Kalman filter.

13. The system of claim 8, wherein the controller is configured to determine the scale factor based on the uncertainty measure by dividing a predetermined goal bias uncertainty value by the uncertainty measure and setting a result of the division as the scale factor.

14. The system of claim 8, wherein the controller is configured to determine the scale factor by:
comparing the uncertainty measure with a threshold bias uncertainty value;
setting the scale factor equal to a predetermined first value if the uncertainty measure is greater than the threshold bias uncertainty value; and
setting the scale factor equal to a predetermined second value if the uncertainty measure is less than or equal to the threshold bias uncertainty value.

15. A non-transitory computer-readable storage medium storing instructions for enabling a processor to execute a method of estimating an orientation of a machine, the method comprising:
receiving, from a first sensor, a first angular rate of the machine measured in a body reference frame of the machine;
determining an estimated bias for a second sensor of the machine and an uncertainty measure for the estimated bias;
determining a scale factor based on the uncertainty measure;
converting the first angular rate of the machine in the body reference frame to a first angular rate of the machine in a gravity reference frame by utilizing a rotation matrix including the scale factor; and
estimating the orientation of the machine based on the first angular rate of the machine in the gravity reference frame.

16. The non-transitory computer-readable storage medium of claim 15, wherein the first angular rate is one of a pitch rate, a roll rate, and a yaw rate of the machine.

17. The non-transitory computer-readable storage medium of claim 15, wherein the rotation matrix further includes a previously estimated orientation of the machine.

18. The non-transitory computer-readable storage medium of claim 15, wherein determining the estimated bias for the second sensor of the machine and the uncertainty measure for the estimated bias includes using a Kalman filter.

19. The non-transitory computer-readable storage medium of claim 15, wherein determining the scale factor based on the uncertainty measure includes dividing a predetermined goal bias uncertainty value by the uncertainty measure and setting a result of the division as the scale factor.

20. The non-transitory computer-readable storage medium of claim 15, wherein determining the scale factor based on the uncertainty measure includes:
comparing the uncertainty measure with a threshold bias uncertainty value;
setting the scale factor equal to a predetermined first value if the uncertainty measure is greater than the threshold bias uncertainty value; and
setting the scale factor equal to a predetermined second value if the uncertainty measure is less than or equal to the threshold bias uncertainty value.
